(19) United States
(12) Patent Application Publication
(10) Pub. No.: US 2026/0110380 A1
(43) Pub. Date: Apr. 23, 2026

(54) Quick Pipe Connector with Visualized Insertion Arrangement

(71) Applicant: TAIZHOU AILUN VALVE CO., LTD, Yuhuan City (CN)

(72) Inventors: Hewen LIANG, Yuhuan (CN); Shicheng LIANG, Yuhuan (CN); Chienyu LIN, New Taipei City (TW); Li ZHOU, Yuhuan (CN)

(21) Appl. No.: 19/224,712

(22) Filed: May 30, 2025

(30) Foreign Application Priority Data
Oct. 19, 2024 (CN) 2024225318559

(51) Int. Cl. F16L 37/091

(52) U.S. Cl. CPC F16L 37/0915; F16L 2201/10

(57) ABSTRACT

A quick pipe connector includes a connector body, an inner sealing ring, an outer sealing ring, a biasing ring sandwiched between the inner sealing ring and the outer sealing ring, a securing ring attached to a connecting portion of the connector body, an engaging member arranged to bias against the securing ring and includes a plurality of catching claws, and a coupling sleeve. The coupling sleeve includes a main sleeve member having a through hole, and an extension sleeve extending from the main sleeve member to engage with the connecting portion of the connector body. When the pipe is inserted in the connector body, the inner sealing ring, the outer sealing ring, the biasing ring, the securing ring and the engaging member are securely biased and retained between the connector body and the main sleeve member.

### CROSS REFERENCES OF RELATED APPLICATIONS

This is a non-provisional application which claims priority of a Chinese patent application having an application number of 2024225318559 and a filing date of Oct. 19, 2024. This application is incorporated by reference herein.

### BACKGROUND OF THE PRESENT INVENTION

### Field of Invention

The present invention relates to connector, and more particularly to a quick pipe connector which comprises a visualized insertion arrangement which is capable of allowing a user to ascertain that a pipe is securely connected to the quick pipe connector.

### Description of Related Arts

Chinese Model Patent (CN220037807U) discloses a quick pipe connector which comprises a main pipe body having a connecting hole, a sealing ring mounted at the connecting hole, in which the sealing ring is capable of forming a sealed arrangement with an inserted pipe. One side of the sealing ring is arranged to be secured by a limiting mechanism arranged at the inner side of the connecting hole, while the other side of the sealing ring is arranged to be secured by a fixed ring. The fixed ring comprises an annular limiting portion biasing against the sealing ring, and an annular mounting portion connected to the main body through an outer sleeve. The outer sleeve comprises a sleeve straight portion connected to an end portion of the main body, and a limiting convex edge extending towards a center of the outer sleeve straight portion in the radial direction at one end of the outer sleeve straight portion. The annular mounting portion is restricted between the limiting convex edge and the main body.

A major disadvantage of the conventional quick pipe connector as described above is that a user will not be able to know when a pipe is securely and correctly fitted in the quick pipe connector. When the connection between the pipe and the quick pipe connector is not secured, leaking may occur.

As a result, there is a need to provide a quick pipe connector which is capable of allowing a user to ascertain that a pipe is securely connected to the quick pipe connector.

### SUMMARY OF THE PRESENT INVENTION

Certain variations of the present invention provide a quick pipe connector which comprises a visualized insertion arrangement which is capable of allowing a user to ascertain that a pipe is securely connected to the quick pipe connector.

Certain variations of the present invention provide a quick pipe connector comprising a visualized insertion arrangement, wherein a user is able to visually observe, from an exterior of the quick pipe connector, a pipe which is being inserted thereto, through a visualized sleeve and window. At the same time, the visualized insertion arrangement ensures that the quick pipe connector does not cause leakage therefrom.

In one aspect of the present invention, it provides a quick pipe connector for connecting to a pipe, comprising:
a connector body having a through passage; and
a visualized insertion arrangement, which comprises:
a visualized sleeve configured from light admissible material mounted in the through passage of the connector body, the visualized sleeve comprising a sleeve body which has a sleeve passage communicating with the through passage, and an insertion slot; and
at least one window formed on the connector body and positioned corresponding to the sleeve body of the visualized sleeve, wherein when the pipe is inserted in the insertion slot of the visualized sleeve, the pipe in the quick pipe connector is visually observable from an exterior of the quick pipe connector through the window and the visualized sleeve.

This summary presented above is provided merely to introduce certain concepts and not to identify any key or essential features of the claimed subject matter.

### BRIEF DESCRIPTION OF THE DRAWINGS

FIG. 1 is a perspective view of a quick pipe connector according to a preferred embodiment of the present invention

FIG. 2 is a sectional side view of the quick pipe connector according to the preferred embodiment of the present invention.

FIG. 3 is a partially enlarged view of FIG. 2.

FIG. 4 is a sectional side view of the quick pipe connector according to a first alternative mode of the preferred embodiment of the present invention.

FIG. 5 is a partially enlarged view of FIG. 4.

FIG. 6 is a perspective view of the quick pipe connector according to the first alternative mode of the preferred embodiment of the present invention, illustrating another configuration of the window.

FIG. 7 is a sectional side view of the quick pipe connector according to the first alternative mode of the preferred embodiment of the present invention, illustrating another configuration of the visualized sleeve.

FIG. 8 is a perspective view of the quick pipe connector according to a second alternative mode of the preferred embodiment of the present invention.

FIG. 9 is a sectional side view of a quick pipe connector according to the second alternative mode of the preferred embodiment of the present invention.

FIG. 10 is a sectional side view of the quick pipe connector according to a third alternative mode of the preferred embodiment of the present invention.

### DETAILED DESCRIPTIONS OF THE PRESENT INVENTION

The following detailed description of the preferred embodiment is the preferred mode of carrying out the invention. The description is not to be taken in any limiting sense. It is presented for the purpose of illustrating the general principles of the present invention.

In the following descriptions, it should also be appreciated that the terms “arrange” and “set” in the following description refer to the connecting relationship in the accompanying drawings for easy understanding of the present invention. For example, the “arrange” and “set” may refer to one element directly or indirectly set or arrange on another element. Therefore, the above terms should not be an actual connection limitation of the elements of the present invention.

It should also be appreciated that the terms “center”, “length”, “width”, “thickness”, “top”, “bottom”, “front”, “rear”, “left”, “right”, vertical”, “horizontal”, “upper”, “lower”, “interior”, and “exterior” in the following description refer to the orientation or positioning relationship in the accompanying drawings for easy understanding of the present invention without limiting the actual location or orientation of the present invention. Therefore, the above terms should not be an actual location limitation of the elements of the present invention.

Moreover, it should be appreciated that the terms “”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of the present invention.

It should be appreciated that the terms “install”, “connect”, “couple”, and “mount” in the following description refer to the connecting relationship in the accompanying drawings for easy understanding of the present invention. For example, the connection may refer to permanent connection or detachable connection. Therefore, the above terms should not be an actual connection limitation of the elements of the present invention.

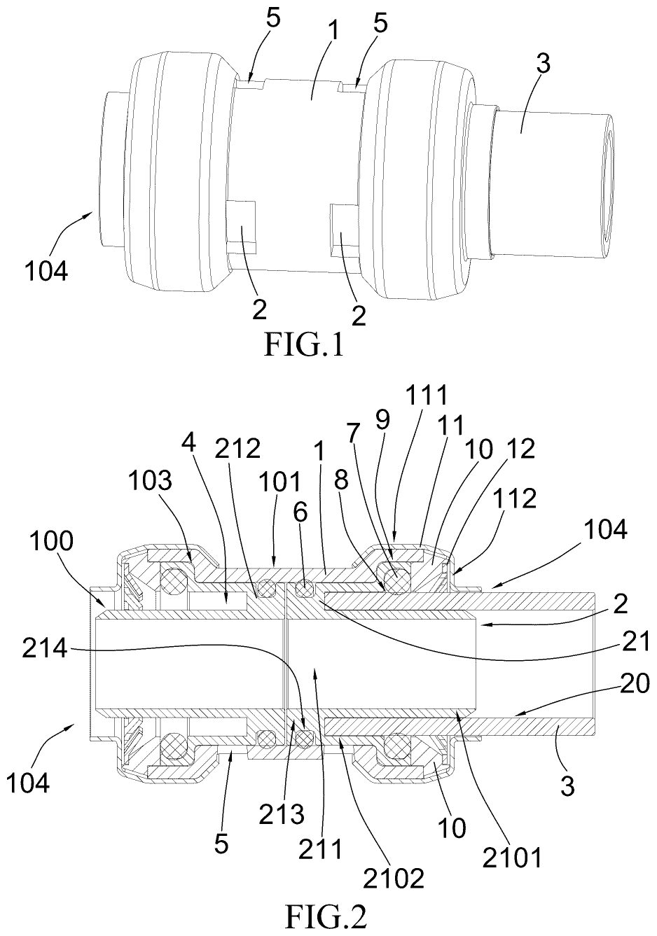

Referring to FIG. 1 to FIG. 3 of the drawings, a quick pipe connector according to a preferred embodiment of the present invention is illustrated. The quick pipe connector may be connected to at least two pipes 3, such as two water pipes. The purpose of the quick pipe connector is to allow convenient and secure connections between at least two pipes 3 so as to allow fluid such as water to flow from one pipe 3 to the other through the quick pipe connector of the present invention. Broadly, the quick pipe connector may comprise a connector body 1 having a through passage 100, and a visualized insertion arrangement 20.

The visualized insertion arrangement 20 may comprise a visualized sleeve 2 and at least one window 5. The visualized sleeve 2 may be mounted in the through passage 100 of the connector body 1. The visualized sleeve 2 may comprise a sleeve body 21 which has a sleeve passage 211 communicating with the through passage 100, and an insertion slot 4.

The window 5 may be formed on the connector body 1 and positioned corresponding to the sleeve body 21 of the visualized sleeve 2, wherein when the pipe 3 is inserted in the insertion slot 4 of the visualized sleeve 2, the pipe 3 in the quick pipe connector may be visually observable from an exterior of the quick pipe connector through the window 5 and the visualized sleeve 2.

The connector body 1 may be configured from rigid, erosive-resistant and strong material such as stainless steel or reinforced composite material. The connector body 1 may have a plurality of openings 104 formed thereon, wherein each of the openings 104 may be connected to a pipe 3, such as a water pipe or a gas pipe. The openings 104 may also communicate with the through passage 100, so that the connector body 1 as a whole may be configured to form a hollow structure.

The quick pipe connector of the present invention provides a rapid and convenient mechanism by which the pipe 3 may be connected thereto and detached therefrom, so that when two or more pipes 3 are connected to the quick pipe connector of the present invention, fluid such as water flowing from one of the connected pipes 3 may flow into the other connected pipe 3 through the quick pipe connector of the present invention. As shown in FIG. 1 to FIG. 2 of the drawings, the connector body 1 may have two openings 104 formed on the left side and the right side of the connector body 1 respectively.

For the sake of clarity, note that the connecting mechanism at each of the openings 104 is structurally identical. The description presented herein is applicable to all openings 104. For example, the descriptions presented above are applicable to one of the openings 104. When the connector body 1 has two openings for connecting two pipes 3, the connection between each pipe 3 and the corresponding opening 104 of the connector body 2 will be identical and will not be repeated throughout this description. The visualized sleeves utilized in each of the openings 104 are also structurally identical and will not be repeated for each opening 104.

The connector body 1 may have a main portion 101, a connecting portion 9 extending from the main portion 101, and the through passage 100 extending through the main portion 101 and the connecting portion 9. The connecting portion 9 may have a cross-sectional diameter larger than that of the main portion 101 so as to constitute an enlarged part with respect to the main portion 101. The connecting portion 9 may radially and outwardly extend from the main portion 101 to be connected to the corresponding pipe 3. The intersection between the connecting portion 9 and the main portion 101 may form a first shoulder 103 in the through passage 100. This first shoulder 103 may be a sidewall in the through passage 100 having a sharp turning or cornering due to a sudden change in diameter.

As shown in FIG. 1 to FIG. 3 of the drawings, the visualized sleeve 2 may be connected to a sidewall of the connector body 1 and may extend through the main portion 101 and the connecting portion 9. The sleeve body 21 of the visualized sleeve 2 may be configured to have a tubular structure and may be provided in the through passage 100 of the connector body 1. The sleeve passage 211 may extend through a longitudinal direction of the sleeve body 21 and communicate with the through passage 100 of the connector body 1. Accordingly, the pipe 3 may be inserted in the quick pipe connector through the opening 104 and extend through the through passage 100 to engage with the sleeve body 21. In the preferred embodiment of the present invention, each opening 104 of the connector body 1 may be equipped with a visualized sleeve 2. Therefore, as shown in FIG. 2 of the drawings, two identical visualized sleeves 2 may be mounted at two openings of the connector body 1.

Note that the sleeve body 21 may be configured from light admissible material so that a user may be able to visually observe the sleeve passage 211 from an exterior of the sleeve body 21. Preferably, the sleeve body 21 may be made transparent to maximize visibility from an exterior thereof. The sleeve body 21 may be configured to have a tubular structure having a circumferential sidewall 212 so that the sleeve passage 211 may be surrounded by the circumferential sidewall 212.

The insertion slot 4 may be formed in the circumferential sidewall 212 along a longitudinal direction of the sleeve body 21 so as to divide the sleeve body 21 into an interior section 2101 and an exterior section 2102. The pipe 3 may be fittedly inserted in the insertion slot 4 so as to connect to the quick pipe connector of the present invention. Thus, a thickness of a circumferential wall of the pipe 3 may correspond to a height of the insertion slot 4 so as to allow fit and tight engagement between the pipe 3 and the insertion slot 4. This tight engagement between the pipe 3 and the insertion slot 4 may facilitate structural reinforcement of the pipe 3 as well as the sleeve body 21 without the need to use additional mechanical components.

On the other hand, the window 5 may be formed on the connector body 1 at a position corresponding to the sleeve body 21 so that when the pipe 3 is inserted in the insertion slot 4, a user is able to visually observe the pipe 3 through the window 5 and the sleeve body 21 (which is configured from light admissible material). As such, the user is able to know if the pipe 3 has been properly inserted in the quick pipe connector. It is important to mention that the visualized insertion arrangement 20 may comprise a plurality of windows 5 formed on the connector body 1 for facilitate easy observation of the pipe 3 in the quick pipe connector.

As shown in FIG. 2 of the drawings, the pipe 3 connected at one opening 104 is in fluid communication with the sleeve passage 211 and the through passage 100 so that fluid flowing through the pipe 3 may be arranged to flow through the quick pipe connector and reach another pipe 3 connected to the other opening 104 (such as an opposed opening 104) of the quick pipe connector.

It is worth mentioning that the window 5 on the connector body 1 may be strategically positioned such that when the user is able to visually observe the pipe 3 from the window 5, this signifies that the pipe 3 has been properly inserted in the quick pipe connector of the present invention. In other words, when the user does not see the pipe 3 from the window 5, it represents that the pipe 3 has not been properly inserted in the quick pipe connector, and the user needs to keep on inserting, realign or re-insert the pipe 3 until he sees the pipe 3 from the window 5.

The visualized insertion arrangement 20 may further comprise a first sealing ring 6 peripherally wrapping around an inner end portion 213 of the sleeve body 21 for preventing fluid leakage. As shown in FIG. 2 of the drawings, the sleeve body 21 may further have an indention 214 circumferentially formed on the inner end portion 213, wherein the first sealing ring 6 may be provided in the indention 214.

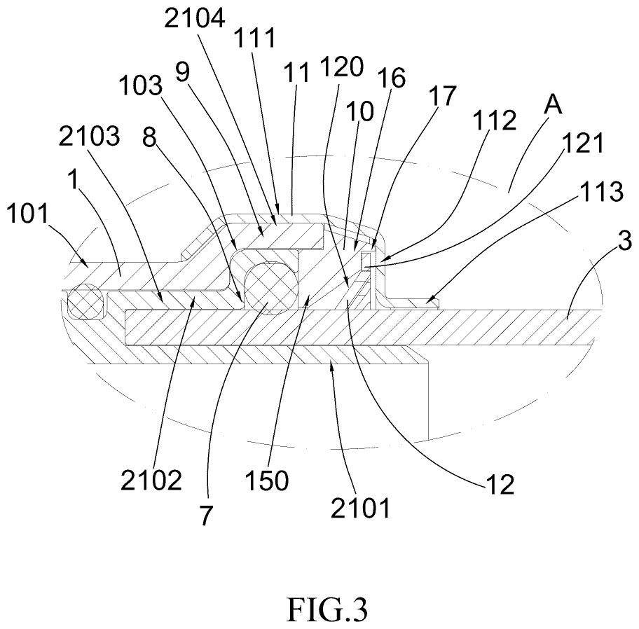

The visualized insertion arrangement 20 may further comprise a second sealing ring 7 provided on the sleeve body 21 at a position underneath the exterior section 2102 for preventing fluid leakage between the pipe 3 and the visualized sleeve 2. More specifically, the exterior section 2102 of the sleeve body 21 may have a narrower portion 2103 and an enlarged storage portion 2104 extending from the narrower portion 2103 to form an accommodating slot 8 surrounded by the enlarged storage portion 2104 for accommodating the second sealing ring 7. Thus, as shown in FIG. 2 to FIG. 3 of the drawings, the second sealing ring 7 may be accommodated in the accommodating slot 8 and tightly surrounded by the enlarged storage portion 2104, an intersection between the narrower portion 2103 and the enlarged storage portion 2104, and an outer surface of the pipe 3.

It is worth mentioning that an inner contour of the connector body 1 may correspond to that of the sleeve body 21 so as to facilitate tight engagement between the sleeve body 21 and the connector body 1. Thus, the narrower portion 2103 may extend along the main portion 101 of the connector body 1, while the enlarged storage portion 2104 may extend along the connecting portion 9 of the connector body 1. An intersection between the narrower portion 2103 and the enlarged storage portion 2104 may be arranged to bias against first shoulder 103 so as to ensure tight engagement between the sleeve body 21 and the connector body 1.

The visualized insertion arrangement 20 may further comprise a securing ring 10 mounted at the opening 104 of the connector body 1 for securing the position of the visualized sleeve 2. As shown in FIG. 2 to FIG. 3 of the drawings, the securing ring 10 may have a generally annular structure and may have a biasing portion 150 arranged to bias against the exterior section 2102 of the sleeve body 21, and a mounting portion 16 arranged to engage with the connecting portion 9 of the connector body 1. The second sealing ring 7 may be securely sandwiched between the biasing portion 150 and the exterior section 2102 of the sleeve body 21 in the accommodating slot 8.

The quick pipe connector of the present invention may further comprise a securing frame 11 mounted on the connector body 1, wherein the securing ring 10 may be mounted on the securing frame 11 and the connector body 1 for securely biasing against the second sealing ring 7 and the exterior section 2102 of the sleeve body 21. The securing frame 11 may be configured to have an annular structure and may have a main securing portion 111 and a block portion 112 peripherally and radially extending from the main securing portion 111 toward a center of the securing frame 11 (i.e. along a transverse direction of the quick pipe connector). The securing ring 10 may thus be embedded by the securing frame 11, the connecting portion 9 of the connector body 1, and the exterior section 2102 of the sleeve body 21, and the second sealing ring 7. In other words, the movement (both radial and longitudinal movements) of the securing ring 10 may be securely restricted by the exterior section 2102 of the sleeve body 21 and the block portion 112 of the securing frame 11. The securing ring 10 may then restrict the movement of the second sealing ring 7. This arrangement may effectively prevent any leakage of fluid from the pipe 3 and the interior section 2101 of the sleeve body 21.

Referring to FIG. 3 of the drawings, the securing ring 10 may further have a receiving slot 17 while the quick pipe connector may further comprise an engaging member 120 which may comprise an annular frame member 121 and a plurality of catching claws 12 extending from the annular frame member 121 toward the main portion 101 of the connector body 1. The annular frame member 121 may be supported in the receiving slot 17 of the securing ring 10, while the catching claws 12 may spacedly extend toward the main portion 101 of the connector body 1.

The receiving slot 17 may be formed on an outer side of the mounting portion 16 and positioned corresponding to the block portion 112 of the securing frame 11. The securing frame 11 may further have an extension portion 113 extending from the block portion 112 along a longitudinal direction of the quick pipe connector for guiding insertion of the pipe 3 into the insertion slot 4 of the sleeve body 21. When the pipe 3 is being inserted in the insertion slot 4, an insertion path thereof may be substantially guided by the extension portion 113.

The window 5 may be formed on the connector body at positions which allow a user to visually observe the pipe 3 in the insertion slot 4. In one embodiment of the present invention, the visualized sleeve 2 may be configured from transparent material, such as thermoplastic material (e.g. polyphenylsulfone (PPSU)).

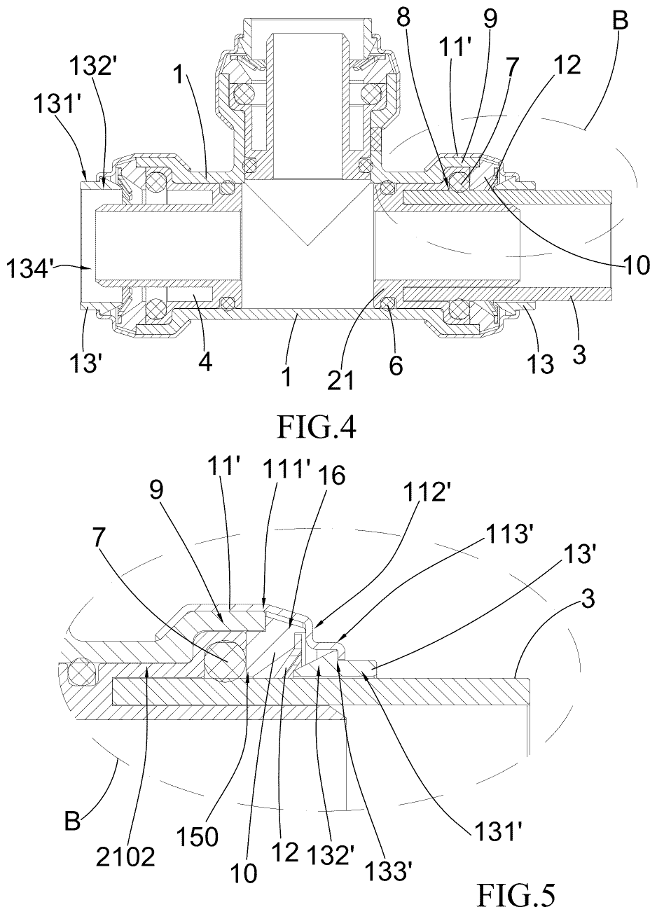

Referring to FIG. 4 to FIG. 5 of the drawings, a quick pipe connector according to a first alternative mode of the preferred embodiment of the present invention is illustrated. The first alternative mode is identical to the preferred embodiment, except the securing frame 11′ and an addition to a pipe detachment member 13′ (described below). In this alternative mode, three openings 104 of the connector body 1 are illustrated as exemplary embodiment. Please note that the structure of the visualized insertion arrangement 20 at each opening 104 is structurally identical.

According to the first alternative mode, the quick pipe connector may further comprise the pipe detachment member 13′ movably coupled to the securing frame 11′ for selectively facilitating release of the pipe 3 from the quick pipe connector. Specifically, the pipe detachment member 13′ may be configured to have an annular structure and may have an outer tubular portion 131′, an inner head portion 132′ extending from the outer tubular portion 131′, and a through passing hole 134′ extending through the outer tubular portion 131′ and the inner head portion 132′ along a longitudinal direction of the quick pipe connector. The pipe detachment member 13′ may be concentrically arranged with respect to the connector body 1. The through passing hole 134′ may be sized and shaped to allow the pipe 3 to pass therethrough and be inserted into the sleeve body 21 of the visualized sleeve 2.

The inner head portion 132′ of the pipe detachment member 13′ may have a diameter gradually increasing from an inner end toward the outer tubular portion 131′ so as to form a tapered cross section of the inner head portion 132′, and a biasing shoulder 133′ at the intersection between the inner head portion 132′ and the outer tubular portion 131′, as shown in FIG. 5 of the drawings.

On the other hand, the securing frame 11′ may be modified to have a main securing portion 111′ extending over the connecting portion 9 of the connector body 1, a block portion 112′ extending from the main securing portion 111′ along a transverse direction of the connector body 1, and an extension portion 113′ extending from the block portion 112′. As in the preferred embodiment described above, the mounting portion 16 of the securing ring 10 may be securely coupled and sandwiched between the exterior section 2102 of the sleeve body 21 and the block portion 112′ of the securing frame 11′.

The extension portion 113′ of the securing frame 11′ may be configured to form a hook structure and engage with the biasing shoulder 133′ of the pipe detachment member 13′. The engagement between the extension portion 113′ and the biasing shoulder 133′ may restrict a longitudinal outward movement of the pipe detachment member 13′.

On the other hand, the pipe detachment member 13′ may be movably mounted on the engagement member 120 in such a manner that the pipe detachment member 13′ may be inwardly pushed for loosening catching claws 12 from the pipe 3. Thus, by inwardly pushing the pipe detachment member 13′, the catching claws 12 may be loosened so as to allow a user to detach the pipe 3 from the quick pipe connector of the present invention.

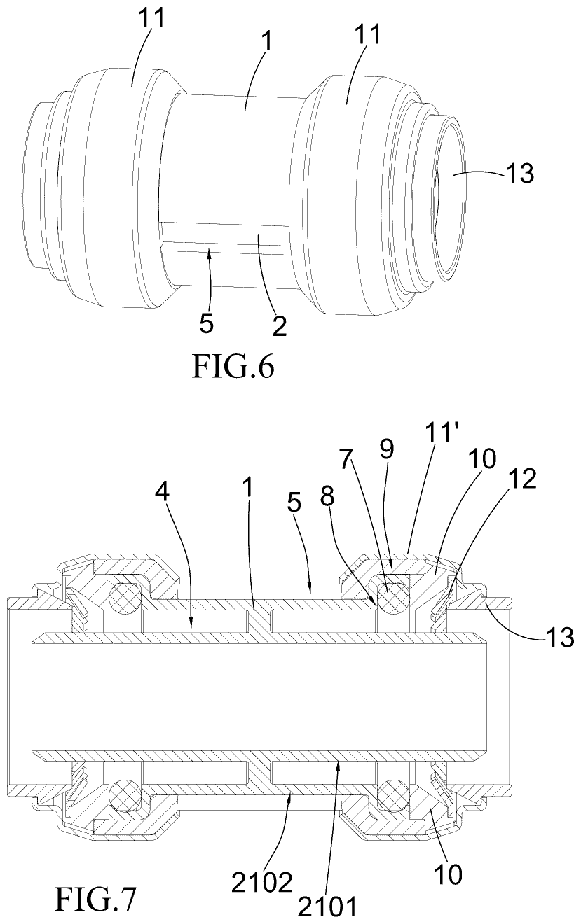

As shown in FIG. 6 and FIG. 7 of the drawings, the visualized insertion arrangement 20 of the present invention may adopt several alternatives with respect to the connector body 1. FIG. 6 illustrates the situation where the window 5 may extend along a longitudinal direction of the connector body 1 such that a single window may allow a user to observe two pipes 3 which are being inserted in the quick pipe connector of the present invention.

FIG. 7 further illustrates that the visualized sleeve 2 mounted at two openings 104 may integrally connect with each other so as to form a single visualized sleeve 2 extending through the through passage 100 of the connector body 1. This may further prevent fluid leak at different components of the quick pipe connector.

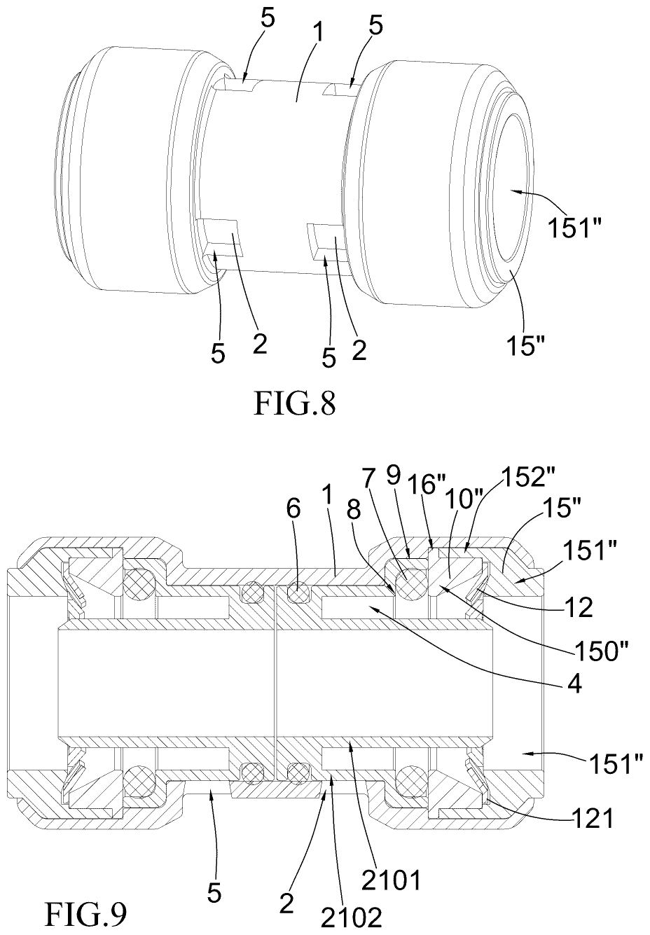

Referring to FIG. 8 to FIG. 9 of the drawings, a quick pipe connector according to a second alternative mode of the preferred embodiment of the present invention is illustrated. The second alternative mode is identical to the preferred embodiment, except the securing ring 10″ and an addition of a tightening ring 15″ (described below).

According to the second alternative mode of the present invention, the securing ring 10″ may be mounted at the opening 104 of the connector body 1 for securing the position of the visualized sleeve 2. As shown in FIG. 9 of the drawings, the securing ring 10″ may also have a generally annular structure and may have a biasing portion 150″ arranged to bias against the exterior section 2102 of the sleeve body 21, and a rim portion 16″ radially extending from the biasing portion 150″ and may be arranged to engage with the tightening ring 15″ (described below). Thus, a diameter of the rim portion 16″ may be larger than that of the biasing portion 150″. The tightening ring 15″ may be securely mounted on the connecting portion 9 of the connector body 1. The second sealing ring 7 may be securely sandwiched between the biasing portion 150″ and the exterior section 2102 of the sleeve body 21 in the accommodating slot 8.

In this second alternative mode of the present invention, the quick pipe connector does not have the securing frame 11 as in the preferred embodiment described above. Rather, the tightening ring 15″ may be mounted on the connector body 1 and bias against the securing ring 10″. The tightening ring 15″ may be configured to have an annular structure and may have a through central hole 151″ communicating with the sleeve passage 211 of the sleeve body 21. As shown in FIG. 5 of the drawings, the tightening ring 15″ may have an outer ring portion 151″ and an inner ring portion 152″ extending from the outer ring portion 151″to engage with the securing ring 10″.

More specifically, the inner ring portion 152″ of the tightening ring 15″ may extend to a space between the connecting portion 9 of the connector body 1 and the biasing portion 150″ of the securing ring 10″. Moreover, the annular frame member 121 of the engaging member 120 may be securely mounted between the tightening ring 15″ and the securing ring 10″. The catching claws 12 of the engaging member 120 may extend from the annular frame member 121 toward the main portion 101 of the connector body 1.

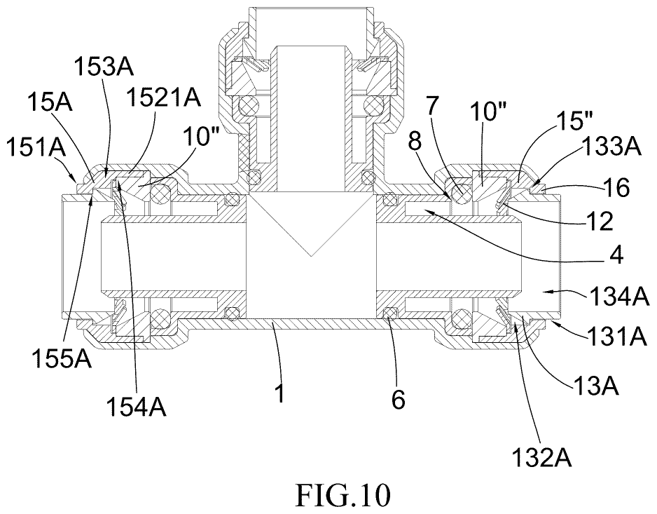

Referring to FIG. 10 of the drawings, a quick pipe connector according to a third alternative mode of the preferred embodiment of the present invention is illustrated. The third alternative mode involves the addition of the pipe detachment member 13A to the configuration described in the second alternative mode. In other words, the third alternative mode of the present invention incorporates the pipe detachment member 13′ described in the first alternative mode to the configuration shown in the second alternative mode.

As shown in FIG. 10 of the drawings, the quick pipe connector may further comprise the pipe detachment member 13A movably coupled to the tightening ring 15A for selectively facilitating release of the pipe 3 from the quick pipe connector.

The pipe detachment member 13A may be configured to have an annular structure and may have an outer tubular portion 131A, an inner head portion 132A extending from the outer tubular portion 131A, and a through passing hole 134A extending through the outer tubular portion 131A and the inner head portion 132A along a longitudinal direction of the quick pipe connector. The pipe detachment member 13A may be concentrically arranged with respect to the connector body 1. The through passing hole 134A may be sized and shaped to allow the pipe 3 to pass therethrough and be inserted into the sleeve body 21 of the visualized sleeve 2.

The inner head portion 132A of the pipe detachment member 13A may have a diameter gradually increasing from an inner end toward the outer tubular portion 131A so as to form a tapered cross section of the inner head portion 132A, and a biasing shoulder 133A at the intersection between the inner head portion 132A and the outer tubular portion 131A.

On the other hand, the tightening ring 15A may be modified as follows: the tightening ring 15A may also be mounted on the connector body 1 and bias against the securing ring 10″. The tightening ring 15A may be configured to have an annular structure and may have a through central hole communicating with the sleeve passage 211 of the sleeve body 21. The tightening ring 15A may have an outer ring portion 151A, an inner ring portion 152A and a middle ring portion 153A extending between the outer ring portion 151A and the inner ring portion 152A.

As shown in FIG. 10 of the drawings, an inner diameter of the inner ring portion 152A is larger than that of the middle ring portion 153A so as to form an inner shoulder 154A at the intersection between the inner ring portion 152A and the middle ring portion 153A. An inner diameter of the middle ring portion 153A is larger than that of the outer ring portion 151A so as to form an outer shoulder 155A at the intersection between the middle ring portion 153A and the outer ring portion 151A.

Thus, the inner shoulder 154A may be arranged to engage with securing ring 10″ while the outer shoulder 155A may be arranged to engage with the biasing shoulder 133A of the pipe detachment pipe 13A.

The pipe detachment member 13A may be movably mounted on the engagement member 120 in such a manner that the pipe detachment member 13A may be inwardly pushed for loosening catching claws 12 from the pipe 3. Thus, by inwardly pushing the pipe detachment member 13A, the catching claws 12 may be loosened so as to allow a user to detach the pipe 3 from the quick pipe connector of the present invention.

The present invention, while illustrated and described in terms of a preferred embodiment and several alternatives, is not limited to the particular description contained in this specification. Additional alternative or equivalent components could also be used to practice the present invention.

What is claimed is:

1. A quick pipe connector for connecting to a pipe, comprising:
a connector body having a through passage; and
a visualized insertion arrangement, which comprises:
a visualized sleeve configured from light admissible material and mounted in the through passage of the connector body, the visualized sleeve comprising a sleeve body which has a sleeve passage communicating with the through passage, and an insertion slot; and
at least one window formed on the connector body and positioned corresponding to the sleeve body of the visualized sleeve, wherein when the pipe is inserted in the insertion slot of the visualized sleeve, the pipe in the quick pipe connector is visually observable from an exterior of the quick pipe connector through the window and the visualized sleeve.

2. The quick pipe connector, as recited in claim 1, wherein the connector body has a main portion, and a connecting portion extending from the main portion, the connecting portion having a cross-sectional diameter larger than that of the main portion, an intersection between the connecting portion and the main portion forming a first shoulder in the through passage.

3. The quick pipe connector, as recited in claim 2, wherein the sleeve body is configured to have a tubular structure having a circumferential sidewall so that the sleeve passage is surrounded by the circumferential sidewall, the insertion slot being formed in the circumferential sidewall along a longitudinal direction of the sleeve body so as to divide the sleeve body into an interior section and an exterior section.

4. The quick pipe connector, as recited in claim 3, wherein the visualized insertion arrangement further comprises a first sealing ring provided peripherally around an inner end portion of the sleeve body, the sleeve body further having an indention circumferentially formed on the inner end portion thereof, wherein the first sealing ring is provided in the indention.

5. The quick pipe connector, as recited in claim 4, wherein the visualized insertion arrangement further comprises a second sealing ring provided on the sleeve body at a position underneath the exterior section, the exterior section of the sleeve body having a narrower portion and an enlarged storage portion extending from the narrower portion to form an accommodating slot surrounded by the enlarged storage portion for accommodating the second sealing ring.

6. The quick pipe connector, as recited in claim 5, wherein the visualized insertion arrangement further comprises a securing ring mounted at the opening of the connector body for securing the position of the visualized sleeve, the securing ring having a generally annular structure and a biasing portion arranged to bias against the exterior section of the sleeve body, and a mounting portion arranged to engage with the connecting portion of the connector body, the second sealing ring being securely sandwiched between the biasing portion and the exterior section of the sleeve body in the accommodating slot.

7. The quick pipe connector, as recited in claim 6, further comprising a securing frame mounted on the connector body, wherein the securing ring is mounted on the securing frame and the connector body for securely biasing against the second sealing ring and the exterior section of the sleeve body, the securing frame being configured to have an annular structure and having a main securing portion and a block portion peripherally and radially extending from the main securing portion toward a center of the securing frame.

8. The quick pipe connector, as recited in claim 7, wherein the securing ring further has a receiving slot while the quick pipe connector further comprises an engaging member which comprises an annular frame member and a plurality of catching claws extending from the annular frame member toward the main portion of the connector body, the annular frame member being supported in the receiving slot of the securing ring, while the catching claws spacedly extending toward the main portion of the connector body.

9. The quick pipe connector, as recited in claim 8, wherein the securing frame further has an extension portion extending from the block portion along a longitudinal direction of the quick pipe connector for guiding insertion of the pipe into the insertion slot of the sleeve body.

10. The quick pipe connector, as recited in claim 6, further comprising a pipe detachment member movably coupled to the securing frame, the pipe detachment member having an outer tubular portion, an inner head portion extending from the outer tubular portion, and a through passing hole extending through the outer tubular portion and the inner head portion along a longitudinal direction of the quick pipe connector.

11. The quick pipe connector, as recited in claim 10, wherein the inner head portion of the pipe detachment member has a diameter gradually increasing from an inner end toward the outer tubular portion so as to form a tapered cross section of the inner head portion, and a biasing shoulder at the intersection between the inner head portion and the outer tubular portion.

12. The quick pipe connector, as recited in claim 11, wherein the securing frame has a main securing portion extending over the connecting portion of the connector body, a block portion extending from the main securing portion along a transverse direction of the connector body, and an extension portion extending from the block portion, the mounting portion of the securing ring being securely coupled and sandwiched between the exterior section of the sleeve body and the block portion of the securing frame.

13. The quick pipe connector, as recited in claim 12, wherein the extension portion of the securing frame is configured to form a hook structure and engage with the biasing shoulder of the pipe detachment member, so that an engagement between the extension portion and the biasing shoulder restricts a longitudinal outward movement of the pipe detachment member.

14. The quick pipe connector, as recited in claim 6, further comprising a tightening ring biasing against the securing ring, wherein the securing ring has a generally annular structure and has a biasing portion arranged to bias against the exterior section of the sleeve body, and a rim portion radially extending from the biasing portion and being arranged to engage with the tightening ring, a diameter of the rim portion being larger than that of the biasing portion, the tightening ring being securely mounted on the connecting portion of the connector body, the second sealing ring being securely sandwiched between the biasing portion and the exterior section of the sleeve body in the accommodating slot.

15. The quick pipe connector, as recited in claim 14, further comprising an engaging member which comprises an annular frame member and a plurality of catching claws extending from the annular frame member toward the main portion of the connector body, the tightening ring being configured to have an annular structure and having a through central hole communicating with the sleeve passage of the sleeve body, the tightening ring having an outer ring portion and an inner ring portion extending from the outer ring portion to engage with the securing ring, the inner ring portion of the tightening ring extending to a space between the connecting portion of the connector body and the biasing portion of the securing ring, the annular frame member of the engaging member being securely mounted between the tightening ring and the securing ring.

16. The quick pipe connector, as recited in claim 6, further comprising a tightening ring mounted on the connector body and bias against the securing ring, the tightening ring being configured to have an annular structure and having a through central hole communicating with the sleeve passage of the sleeve body, the tightening ring having an outer ring portion, an inner ring portion and a middle ring portion extending between the outer ring portion and the inner ring portion, an inner diameter of the inner ring portion being larger than that of the middle ring portion so as to form an inner shoulder at the intersection between the inner ring portion and the middle ring portion, an inner diameter of the middle ring portion being larger than that of the outer ring portion so as to form an outer shoulder at the intersection between the middle ring portion and the outer ring portion.

17. The quick pipe connector, as recited in claim 16, further comprising a pipe detachment member movably coupled to the tightening ring, the pipe detachment member having an outer tubular portion, an inner head portion extending from the outer tubular portion, and a through passing hole extending through the outer tubular portion and the inner head portion along a longitudinal direction of the quick pipe connector, the inner head portion of the pipe detachment member having a diameter gradually increasing from an inner end toward the outer tubular portion so as to form a tapered cross section of the inner head portion, and a biasing shoulder at the intersection between the inner head portion and the outer tubular portion, the inner shoulder being arranged to engage with securing ring while the outer shoulder being arranged to engage with the biasing shoulder of the pipe detachment pipe.
